(19) United States
(12) Patent Application Publication
(10) Pub. No.: US 2015/0092326 A1
(43) Pub. Date: Apr. 2, 2015

(54) DETACHABLE SCREEN ACCESSORY

(71) Applicant: KOBO Incorporated, Toronto (CA)

(72) Inventors: Ramesh MANTHA, Toronto (CA); Damien LEWIS, Toronto (CA)

(73) Assignee: KOBO Incorporated, Toronto (CA)

(21) Appl. No.: 14/042,286

(22) Filed: Sep. 30, 2013

(51) Int. Cl. G06F 1/16

(52) U.S. Cl. CPC G06F 1/1647; G06F 1/1626
USPC 361/679.3

(57) ABSTRACT

Detachable screen accessory. In accordance with a first embodiment, an apparatus includes an electronic display screen is mounted to a shell. A docking housing is mechanically coupled to the shell, opposite the electronic display screen. The docking housing is configured to mechanically capture a second electronic device. The second electronic device includes a second electronic device display screen. The apparatus also includes first circuitry configured to communicatively couple to the second electronic device, and second circuitry configured to display information from the second electronic device on the electronic display screen. The second electronic device may include a smart phone.

### FIELD OF INVENTION

Embodiments of the present invention relate to the field of devices with electronic displays. More specifically, embodiments of the present invention relate to systems and methods for detachable screen accessories.

### BACKGROUND

The electronic display screens of portable electronic systems, e.g., “smart” phones, tablet computers, and/or personal digital assistants, “wearable” electronic systems, including, e.g., “smart” watches and/or glasses, are often less than desirable for some uses. For example, many such devices employ back-lit liquid crystal display (LCD) display screens. Such LCD display screens are notoriously difficult to see in bright light or direct sunlight, e.g., outdoors. In addition, LCD displays generally have a much higher power consumption, which directly leads to an undesirably shorter battery life, in comparison to other display technologies, e.g., electronic paper (e-paper). Further, such displays may have less than desirable contrast. Organic light emitting diode (OLED) displays have similar drawbacks. Still further, the native display of such devices may be undesirably small for some uses, e.g., an e-reader application.

### SUMMARY OF THE INVENTION

Therefore, what is needed are systems and methods for detachable screen accessories that provide an improved viewing arrangement for viewing intensive applications. What is additionally needed are systems and methods for detachable screen accessory that leverage resources of existing companion devices while improving viewability of information. A further need exists for systems and methods for detachable screen accessory that are compatible and complementary with existing systems and methods of electronic display construction, operation and programming. Embodiments of the present invention provide these advantages.

In accordance with a first embodiment, an apparatus includes an electronic display screen is mounted to a shell. A docking housing is mechanically coupled to the shell, opposite the electronic display screen. The docking housing is configured to mechanically secure a second electronic device. The second electronic device includes a second electronic device display screen. The apparatus also includes first circuitry configured to communicatively couple to the second electronic device, and second circuitry configured to display information from the second electronic device on the electronic display screen. The second electronic device may include a smart phone.

In accordance with another embodiment of the present invention, an apparatus includes a shell and a hinge for folding the shell about in half. A docking housing is mechanically coupled to the shell on a first side of the hinge. The docking housing is configured to mechanically capture a second electronic device. The second electronic device includes a second electronic device display screen. The apparatus also includes an accessory electronic device, including an accessory electronic device display screen, functionally coupled to the shell on a second side of the hinge. The accessory electronic device is configured to display information received from the second electronic device on the accessory electronic device display screen.

In accordance with a method embodiment of the present invention, a detachable screen accessory is communicatively coupled with a second electronic device. Responsive to the coupling, the detachable screen accessory is activated. Information is displayed on the detachable screen accessory received from the second electronic device. The information is a portion of an electronic book.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1A illustrates a front or “screen side” view of an exemplary detachable screen accessory, in accordance with embodiments of the present invention.

FIG. 1B is an exemplary block diagram of an exemplary detachable screen accessory, in accordance with embodiments of the present invention.

FIG. 2A illustrates a rear, or non-screen side, view of an exemplary detachable screen accessory, in accordance with embodiments of the present invention.

FIG. 2B illustrates a rear perspective view of exemplary detachable screen accessory, in accordance with embodiments of the present invention.

FIG. 3A illustrates an exemplary detachable screen accessory, in accordance with embodiments of the present invention.

FIG. 3B illustrates a several perspective views of exemplary detachable screen accessory, in accordance with embodiments of the present invention.

FIG. 4 illustrates a method, in accordance with embodiments of the present invention.

FIG. 5 illustrates a method, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### Notation and Nomenclature

Some portions of the detailed descriptions which follow (e.g., methods 400, 500) are presented in terms of procedures, steps, logic blocks, processing, and other symbolic representations of operations on data bits that may be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “displaying” or “detecting” or “determining” or “setting” or “accessing” or “placing” or “testing” or “forming” or “mounting” or “removing” or “ceasing” or “stopping” or “coating” or “attaching” or “processing” or “performing” or “generating” or “adjusting” or “creating” or “executing” or “continuing” or “indexing” or “computing” or “translating” or “calculating” or “determining” or “measuring” or “gathering” or “running” or the like, refer to the action and processes of, or under the control of, a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Detachable Screen Accessory

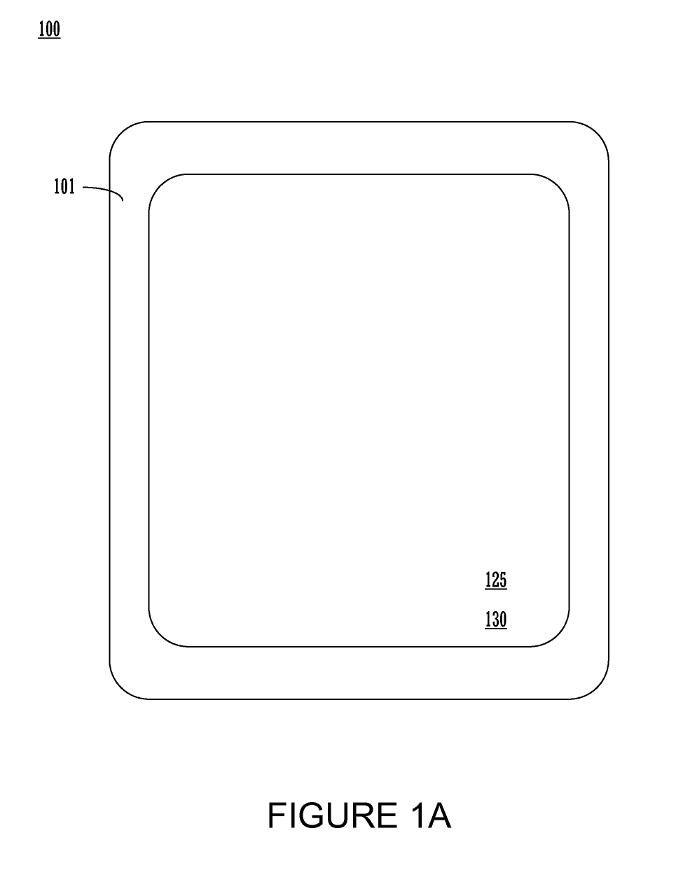

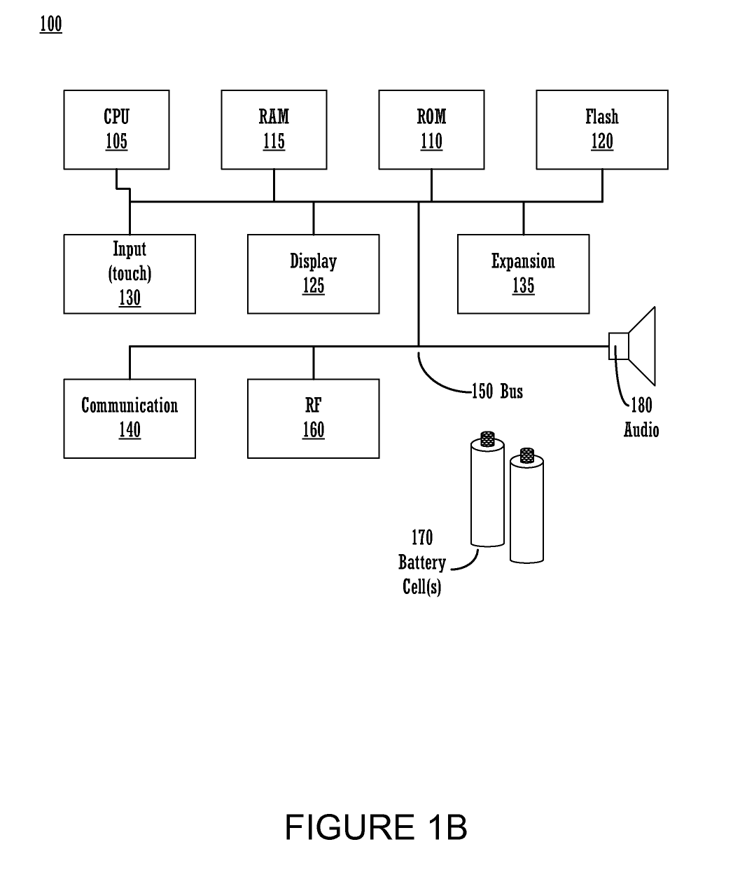

FIG. 1A illustrates a front or “screen side” view of an exemplary detachable screen accessory 100, in accordance with embodiments of the present invention. Detachable screen accessory 100 is enclosed in a case or shell 101 of any suitable material. Detachable screen accessory 100 comprises a display unit 125 and may comprise an optional touch sensitive digitizer panel 130, also known as or referred to as a “touch screen.” Touch sensitive digitizer panel 130 operates to indentify a point of contact of a finger, stylus or other object. The display unit 125 may appear to extend to one of more edges of the device 100. For example, the detachable screen accessory 100 may appear to be “bezel-less.”

FIG. 1B is an exemplary block diagram of an exemplary detachable screen accessory 100, in accordance with embodiments of the present invention. Detachable screen accessory 100 may be battery-powered, e.g., via cells 170, in some embodiments. Cells 170 may be primary or secondary cells, for example. Detachable screen accessory 100 includes an address/data bus 150 for communicating information, a central processor 105 functionally coupled with the bus for processing information and instructions. Central processor 105 may comprise multiple processors, e.g., a multi-core processor, or multiple separate processors, in some embodiments. Detachable screen accessory 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Volatile memory 115 may also include display memory, e.g., a frame buffer. Detachable screen accessory 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in detachable screen accessory 100 of FIG. 1 is an optional input device 130. Device 130 can communicate information and command selections to the central processor 100. Input device 130 may be any suitable device for communicating information and/or commands to the detachable screen accessory 100. For example, input device 130 may take the form of buttons, a joystick, a track ball, an audio transducer, e.g., a microphone, a touch sensitive digitizer panel, eyeball scanner and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the detachable screen accessory 100, in some embodiments. For example, capacitive touch panels may sense proximity of a user's finger.

The display unit 125 utilized with the detachable screen accessory 100 may comprise, for example, a liquid crystal display (LCD) device, cathode ray tube (CRT), field emission device (FED, also called flat panel CRT), light emitting diode (LED, OLED), plasma display device, electro-luminescent display, electrophoretic display, electronic paper, electronic ink (e-ink) or other display device suitable for creating graphic images and/or alphanumeric characters for viewing by a user. Display unit 125 may have an associated lighting device, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the detachable screen accessory 100.

Detachable screen accessory 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express (PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may consist of signals substantially compliant with the signals of bus 150.

A wide variety of well known devices may be attached to detachable screen accessory 100 via the bus 150 and/or expansion interface 135. Examples of such devices include without limitation rotating magnetic memory devices, flash memory devices, digital cameras, wireless communication modules, digital audio players, “smart phones,” tablet computers, e-readers, Global Positioning System (GPS) devices, and the like.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394 and synchronous ports. Detachable screen accessory 100 may be able to receive electrical power through expansion interface 135 and/or communication port 140, in some embodiments.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of detachable screen accessory 100 may be implemented by a combination of hardware and/or software. Detachable screen accessory 100 may comprise additional software and/or hardware features (not shown) in some embodiments.

Detachable screen accessory 100 may also optionally include audio input and/or output devices 180, e.g., a microphone and/or one or more speakers. Audio input and/or output devices 180 may be coupled to bus 150 in any suitable manner, e.g., via analog or digital signals, or through intermediary devices, e.g., amplifiers, analog/digital converters and the like. Audio input and/or output devices 180 may be used for recognition of voice commands, in some embodiments.

In accordance with embodiments of the present invention, a detachable screen accessory, e.g., detachable screen accessory 100 may be communicatively coupled with a second electronic device, e.g., a smart phone or tablet computer or the like, to provide improved viewing of information provided by such second electronic device. The communicative coupling may comprise, for example, a wired coupling, e.g., via a smart phone docking port or a USB port or cable, in some embodiments. In some embodiments, the communicative coupling may comprise a wireless coupling, e.g., via IEEE 802.11 (“Wi-Fi”), Bluetooth or the like. Embodiments in accordance with the present invention may comprise hardware and/or software for wired, wireless or both types of communication with a second electronic device.

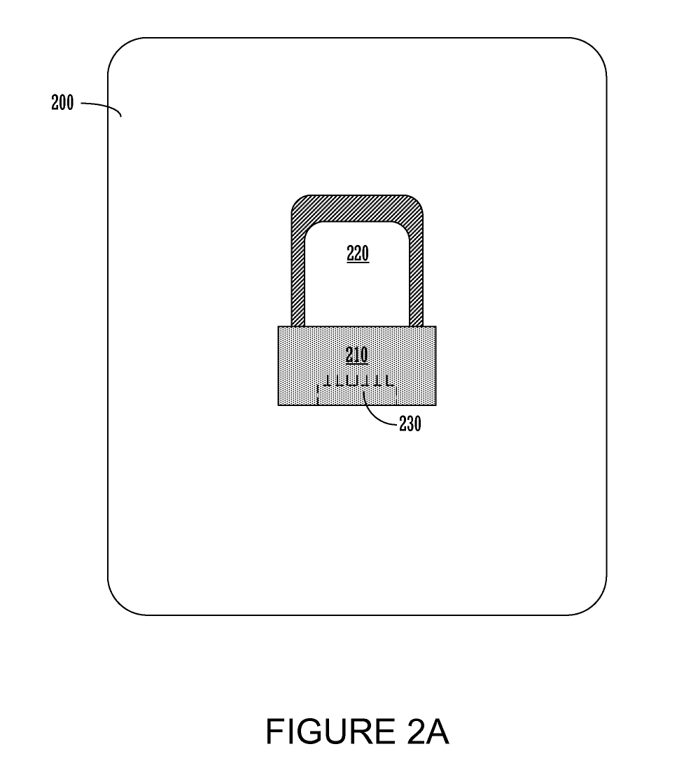

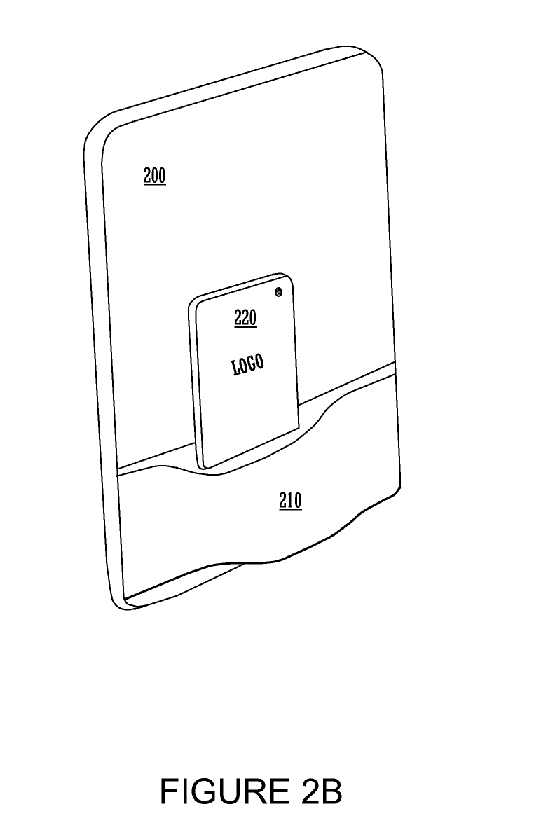

FIG. 2A illustrates a rear, or non-screen side, view of an exemplary detachable screen accessory 200, in accordance with embodiments of the present invention. Detachable screen accessory 200 comprises a display screen (obscured in this view) and appropriate other hardware as described previously with respect to detachable screen accessory 100 of FIG. 1B. In addition, detachable screen accessory 200 comprises a docking housing 210 for mechanically and communicatively coupling with a second electronic device 220. Second electronic device 220 may comprise a smart phone or tablet computer, in some embodiments. The display screen of detachable screen accessory 200 may be larger than a screen of second electronic device 220, although that is not required.

Docking housing 210 provides mechanical support and secures second electronic device 220 while attached to detachable screen accessory 200. There may be additional mechanical features for retaining second electronic device 220, in some embodiments. Docking housing 210 may, in some embodiments, comprise an electrical connector 230, for electrically coupling with second electronic device 220. Electrical connector 230 may comprise any appropriate connector system, including standard connectors, e.g., USB connectors, and/or proprietary connectors, e.g., as are well known for smart phones. Electrical connector 230 may conduct electrical power, for example, from second electronic device 220 to detachable screen accessory 200 and/or vice versa, in some embodiments.

Second electronic device 220 may sit flush with a back cover of detachable screen accessory 200, or may be partially or fully captured or secured within a recess of detachable screen accessory 200, in accordance with embodiments of the present invention. Second electronic device 220 may face in towards detachable screen accessory 200, or may face outwards, as illustrated in FIG. 2A.

Detachable screen accessory 200 is communicatively coupled to second electronic device 220 to exchange commands and information. The communication may take place via electrical signals over electrical connector 230, or via non-conductive paths, e.g., inductive, optical and/or radio frequency signaling, in a variety of embodiments.

In accordance with embodiments of the present invention, second electronic device 220 transfers information to detachable screen accessory 200 for detachable screen accessory 200 to display such information. Detachable screen accessory 200 may comprise a display that is better suited to display of the information than second electronic device 220. For example, the display screen of detachable screen accessory 200 may be larger, have a higher contrast ratio, have a more “paper-like” appearance, have less flicker, have less glare and/or consume less power in comparison to a display screen of second electronic device 220.

For example, in an exemplary use of detachable screen accessory 200, a smart phone 220 comprising a relatively small liquid crystal display (LCD) is plugged into a docking housing 210 of detachable screen accessory 200. Responsive to the docking action, smart phone 220 turns off its display and begins providing electrical power to detachable screen accessory 200, e.g., via electrical connector 230. Smart phone 220 then transfers information of a page of an e-book to detachable screen accessory 200. The information may take any suitable form, including textual information, formatted or unformatted image information and/or a frame buffer for display on a display of detachable screen accessory 200. In some embodiments, the information may be compressed, e.g., to maximize available bandwidth of a transmission media. The information may be previously resident on the smart phone 220, or it may be obtained, for example, in a streaming manner, e.g., via a mobile data link, temporally proximate to the communication to detachable screen accessory 200.

In some embodiments, detachable screen accessory 200 comprises minimal hardware and software to implement a minimal functionality to display information received from second electronic device 220. In such embodiments, the majority of processing may be performed by the second electronic device 220. In other embodiments, detachable screen accessory 200 comprises a high function, and has substantial computing resources of its own. All such embodiments, including intermediate embodiments, are considered within the scope of the present invention.

Continuing the usage example, detachable screen accessory 200 may be able to accept command and control inputs, e.g., via hard buttons, “soft” keys, gestures and the like, for example via a touch sensitive digitizer panel 130 (FIG. 1A) and communicate such commands and controls to the smart phone 220. In this manner, a user is able to advantageously view, e.g., read, information from second electronic device 220 displayed on detachable screen accessory 200. The viewing on detachable screen accessory 200 may be “better” than similar viewing on the second electronic device 220. For example, the display screen of detachable screen accessory 200 may be larger and capable of displaying more information in a more viewable size and/or format. Detachable screen accessory 200 may have a higher contrast ratio, have less flicker, and/or have less glare resulting in beneficially reduced viewing fatigue. Detachable screen accessory 200 may consume less power in comparison to a display screen of second electronic device 220, resulting in an advantageous increase in battery life in comparison to a similar viewing action performed on the display of second electronic device 220.

For example, the display screen of detachable screen accessory 200 may comprise a display technology, e.g., electronic paper, that is more suited to some uses, e.g., reading an electronic book, than an LCD or OLED display as is common to smart phones. Accordingly, embodiments in accordance with the present invention may enable extended viewing on a larger screen with a higher contrast, “paper-like” display, at less energy cost, in comparison to reading the same book from the smart phone's native display. The above-described usage model is not to be considered limiting.

In some embodiments, the second electronic device 220 may provide all electrical power for both second electronic device 220 and detachable screen accessory 200. For example, the energy cost of operating a backlit thin-film-transistor liquid-crystal display (TFT LCD) of the smart phone 220 may be greater than an energy cost of operating the entire detachable screen accessory 200, including a larger display, e.g., comprising a different technology. In such embodiments, by turning off the native display of the second electronic device 220 and utilizing detachable screen accessory 200, an overall battery life of the combination of devices may be extended, in comparison to the second electronic device 220 by itself.

Detachable screen accessory 200 may be deactivated in response to a command input directly to detachable screen accessory 200, in response to a command from second electronic device 220 or in response to a removal of second electronic device 220 from docking housing 210.

FIG. 2B illustrates a rear perspective view of exemplary detachable screen accessory 200, in accordance with embodiments of the present invention. In the embodiment of FIG. 2B, second electronic device 220 is docked with its screen facing detachable screen accessory 200. This alignment makes a rear-facing camera available for use.

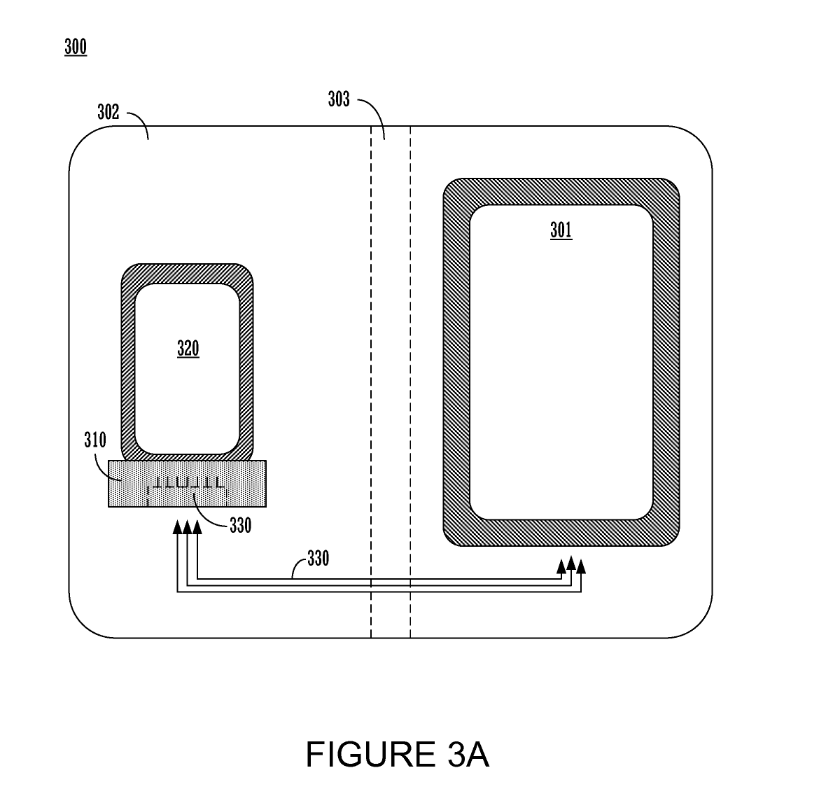

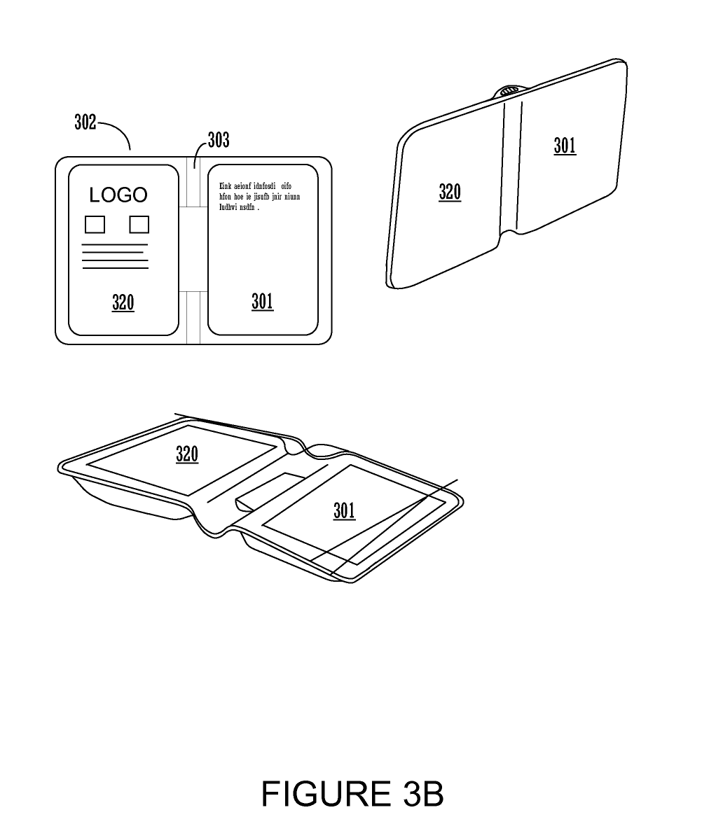

FIG. 3A illustrates an exemplary detachable screen accessory 300, in accordance with embodiments of the present invention. Detachable screen accessory 300 comprises an accessory electronic device 301. Accessory electronic device 301 is generally comparable to detachable screen accessory 100 of FIG. 1B. Detachable screen accessory 300 comprises a shell 302 of rigid or semi-rigid material, e.g., plastic, metal, leather, and/or the like. Shell 302 supports accessory electronic device 301 on one side (right, as illustrated in FIG. 3A) and a docking housing 310 on the other. Docking housing 310 is generally comparable to docking housing 210, as illustrated in FIG. 2A. Accessory electronic device 301 may be permanently or removably attached to shell 302.

Docking housing 310 provides mechanical support and captures or secures second electronic device 320 while attached to shell 302 of detachable screen accessory 300. The screen and/or housing of accessory electronic device 301 may be larger than a screen and/or housing of second electronic device 320, although that is not required. Docking housing 310 may, in some embodiments, comprise an electrical connector 330, for electrically coupling second electronic device 320 to accessory electronic device 301.

Shell 302 may fold substantially in half along hinge 303. Hinge 303 may be a discrete hinge, or it may be a living hinge, in some embodiments. Optional bus 330 may provide an electrical path for signals and/or power between second electronic device 320 and accessory electronic device 301. Bus 330 traverses hinge 303. When folded, detachable screen accessory 300, with or without second electronic device 220, may resemble a book or portfolio.

Detachable screen accessory 300 may comprise one or more batteries, for example, within hinge 303, in some embodiments. In some embodiments, detachable screen accessory 300 may receive power from second electronic device 320.

The display screen of the second electronic device 320 may or may not be operational while accessory electronic device 301 is operational. For example, accessory electronic device 301 may lack a touch screen and/or buttons. A touch screen, e.g., comprising soft keys, on second electronic device 320 may provide input operations of the combination of devices while the accessory electronic device 301 provides most or all of the display function. The displays of second electronic device 320 and accessory electronic device 301 may operate cooperatively, in some embodiments. For example, the display of accessory electronic device 301 may display a “zoomed” image of a smaller image displayed on the display of second electronic device 320.

In accordance with embodiments of the present invention, accessory electronic device 301 may be activated responsive to docking of second electronic device 320. In accordance with other embodiments of the present invention, accessory electronic device 301 may be activated responsive to a command from second electronic device 320. For example, a quiescent state of detachable screen accessory 300 may have a second electronic device 320 docked, but in an “off” or “standby” mode of operation. Responsive to user command, second electronic device 320 is turned on in accordance with its normal operation. In response to a user command, e.g., selection of a software “app,” second electronic device 320 commands accessory electronic device 301 to display information provided by the second electronic device 320.

In still other embodiments of the present invention, one or both of second electronic device 320 and/or accessory electronic device 301 may be activated responsive to opening of shell 302 from a closed or folded condition. Similarly, one or both of second electronic device 320 and/or accessory electronic device 301 may be deactivated responsive to closing of shell 302 from an open or unfolded condition. Activation and/or deactivation may comprise any suitable technology, including for example, a mechanical switch for detecting a position of hinge 303, a light sensor, or a magnet and magnetic, e.g., Hall effect, sensor combination.

FIG. 3B illustrates a several perspective views of exemplary detachable screen accessory 300, in accordance with embodiments of the present invention. It is to be appreciated that in the view of FIG. 3B, the second electronic device 320 is approximately the same size as the accessory electronic device 301, e.g., both are “tablet” sized.

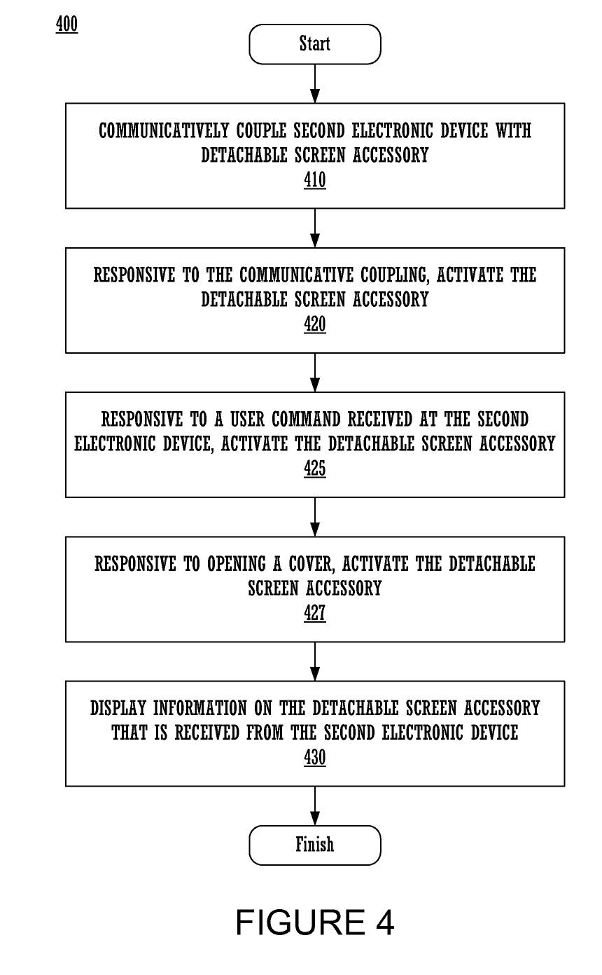

FIG. 4 illustrates a method 400, in accordance with embodiments of the present invention. In 410, a second electronic device, e.g., second electronic device 320 of FIG. 3A, is communicatively coupled with a detachable screen accessory, e.g., detachable screen accessory 302 of FIG. 3A. The communicative coupling may take any suitable form, e.g., a conductive path, an inductive path, an optical path and/or a radio frequency path.

In optional 420, responsive to the communicative coupling, the detachable screen accessory is activated, e.g., a display screen turns on. In optional 425, subsequent to the communicative coupling, the detachable screen accessory is activated responsive to a user command entered into the second electronic device. For example, a user touches an icon representing a software program. In optional 427, subsequent to the communicative coupling, the detachable screen accessory is activated responsive to opening a cover, e.g., shell 302 of FIG. 3A. In optional 420, 425 and/or 427, activating the detachable screen accessory may comprise the second electronic device providing electrical power to the detachable screen accessory, in some embodiments.

In 430, information is displayed on the detachable screen accessory that is received from the second electronic device.

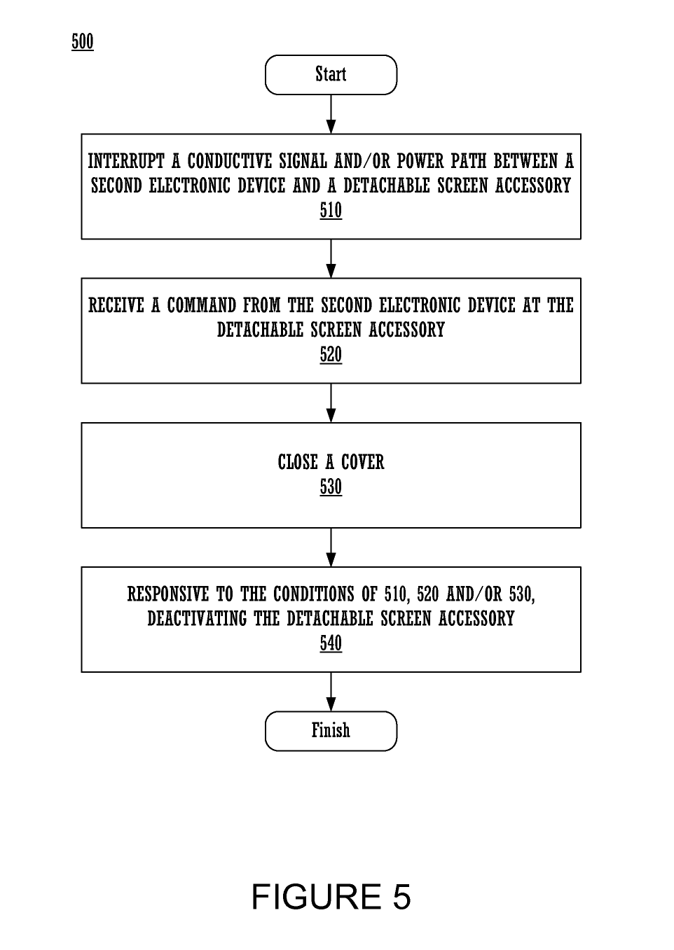

FIG. 5 illustrates a method 500, in accordance with embodiments of the present invention. In optional 510, a conductive signal and/or power path between a second electronic device, e.g., second electronic device 320 of FIG. 3A, and a detachable screen accessory, e.g., detachable screen accessory 302 of FIG. 3A, is interrupted. For example, second electronic device 320 is removed from docking housing 310 (FIG. 3A).

In optional 520, a command is received from the second electronic device at the detachable screen accessory. The command may be generated automatically by software in response to a variety of conditions, e.g., completion of a software program, e.g., an e-book reader application. In some embodiments, the command may be responsive to a user action, e.g., touching a soft button on the second electronic device. In optional 530, a cover, e.g., shell 302 of FIG. 3A, is closed.

In 540, responsive to the conditions of 510, 520 and/or 530, the detachable screen accessory is deactivated. For example, the detachable screen accessory display stops displaying information. The deactivation may comprise terminating a supply of electrical power to the detachable screen accessory, in some embodiments.

Embodiments in accordance with the present invention provide systems and methods for detachable screen accessories that provide an improved viewing arrangement for viewing intensive applications. In addition, embodiments in accordance with the present invention provide systems and methods for detachable screen accessories that leverage resources of existing companion devices while improving viewability of information. Further, embodiments in accordance with the present invention provide systems and methods for detachable screen accessories that are compatible and complementary with existing systems and methods of electronic display construction, operation and programming.

Various embodiments of the invention are thus described. While the present invention has been described in particular embodiments, it should be appreciated that the invention should not be construed as limited by such embodiments, but rather construed according to the below claims.

What is claimed is:

1. An apparatus comprising:
an electronic display screen mounted to a shell;
a docking housing mechanically coupled to said shell, opposite said electronic display screen,
wherein said docking housing is configured to mechanically secure a second electronic device, wherein said second electronic device comprises a second electronic device display screen; and
first circuitry configured to communicatively couple to said second electronic device;
second circuitry configured to display information from said second electronic device on said electronic display screen.

2. The apparatus of claim 1 wherein said second electronic device comprises a smart phone.

3. The apparatus of claim 1 wherein said second electronic device comprises a tablet computer.

4. The apparatus of claim 1 wherein said second electronic device display screen comprises a different display technology from said electronic display.

5. The apparatus of claim 1 wherein said docking housing comprises a connector for forming an electrically conductive path between said second electronic device and said apparatus.

6. The apparatus of claim 1 wherein said first circuitry is configured to communicate via radio frequency communications.

7. The apparatus of claim 1 wherein said electronic display screen comprises electrophoretic display technology.

8. The apparatus of claim 1 wherein said second circuitry receives electrical power from said second electronic device.

9. An apparatus comprising:
a shell;
a hinge for folding said shell about in half;
a docking housing mechanically coupled to said shell on a first side of said hinge,
wherein said docking housing is configured to mechanically capture a second electronic device, wherein said second electronic device comprises a second electronic device display screen;
an accessory electronic device, comprising an accessory electronic device display screen, functionally coupled to said shell on a second side of said hinge, and
wherein said accessory electronic device is configured to display information received from said second electronic device on said accessory electronic device display screen.

10. The apparatus of claim 9 wherein said second electronic device comprises a smart phone.

11. The apparatus of claim 9 wherein said second electronic device comprises a tablet computer.

12. The apparatus of claim 9 wherein said second electronic device display screen comprises a different display technology from said accessory electronic device display screen.

13. The apparatus of claim 9 wherein said docking housing comprises a connector for forming an electrically conductive path between said second electronic device and said accessory electronic device.

14. The apparatus of claim 9 configured to communicate between said second electronic device and said accessory electronic device via radio frequency communications.

15. The apparatus of claim 9 wherein said shell comprises a conductive signal path between said second electronic device and said accessory electronic device that crosses said hinge.

16. The apparatus of claim 9 wherein said accessory electronic device is configured to activate responsive to opening said shell from a folded closed position.

17. The apparatus of claim 9 wherein said accessory electronic device is configured to receive electrical power from said second electronic device.

18. The apparatus of claim 9 wherein said accessory electronic device is removable from said shell.

19. The apparatus of claim 9 wherein said shell comprises an electrical power source independent of said second electronic device or said accessory electronic device.

20. A method comprising:
communicatively coupling a detachable screen accessory with a second electronic device;
responsive to the coupling, activating the detachable screen accessory; and
displaying information on said detachable screen accessory received from said second electronic device, wherein said information is a portion of an electronic book.
